(19) United States
(12) Patent Application Publication
(10) Pub. No.: US 2026/0170445 A1
(43) Pub. Date: Jun. 18, 2026

(54) SYSTEMS AND METHODS FOR KEY PERFORMANCE INDICATOR RECOMMENDATIONS

(71) Applicant: ServiceNow, Inc., Santa Clara, CA (US)

(72) Inventors: Amir Ligata, Antwerp (BE); Amit Kumar, Bengaluru (IN); Zahi Boussiba, Ramat Gan (IL); Can Bikcora, Eindhoven (NL); Thais Bittencourt Lorenzini, Amsterdam (NL); Kinnie Fuentes Ganancial, Amsterdam (NL); Cuong Minh Hoang, Amsterdam (NL); Shayan Shahand, Amsterdam (NL)

(21) Appl. No.: 19/419,842

(22) Filed: Dec. 15, 2025

Related U.S. Application Data
(60) Provisional application No. 63/735,503, filed on Dec. 18, 2024.

(51) Int. Cl. G06Q 10/0639

(52) U.S. Cl. CPC G06Q 10/06393

(57) ABSTRACT

This disclosure is directed to a system and a method for key performance indicator recommendations. In an embodiment of this disclosure, the method may be practiced by first retrieving, via a call to an API endpoint, key performance indicator (KPI) data corresponding to a plurality of KPIs. Then, the method includes identifying a plurality of anomalies in the KPI data, wherein each anomaly of the plurality of anomalies corresponds to a respective KPI of the plurality of KPIs. The method includes generating A plurality of notifications based on the plurality of anomalies, wherein each of the plurality of notifications includes information about a respective anomaly of the plurality of anomalies. The method includes ranking plurality of notifications based on a ranking of the plurality of KPIs. Lastly, the method includes transmitting the plurality of notifications to a client device for display within a dashboard.

### CROSS REFERENCE TO RELATED APPLICATIONS

This application claims priority from and the benefit of U.S. Provisional Patent Application No. 63/735,503, entitled “SYSTEM AND METHOD FOR KEY PERFORMANCE INDICATOR RECOMMENDATIONS”, filed Dec. 18, 2024, which is herein incorporated by reference in its entirety for all purposes.

### TECHNICAL FIELD

The present disclosure relates generally to a system and method for generating and organizing key performance indicator notifications and suggestions.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g., computing devices, load balancers, firewalls, switches, etc.) and software resources (e.g., productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In modern communication networks, examples of cloud computing services a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for users to develop, modify, and/or customize applications and/or automate enterprise operations without maintaining network infrastructure and/or allocating computing resources normally associated with these functions.

Within cloud-computing infrastructure such as those described above, key performance indicators (KPIs) may include measurable values used to assess an enterprise's operations, and can be used to identify trends and make data-driven decisions. KPIs may be aggregated and displayed as one or more data visualizations on a dashboard. These visualizations can include score displays, pie charts, bar charts, and so on. However, as more data visualizations of KPIs are added to the dashboard, it becomes difficult to navigate the dashboard and to notice anomalies in the data visualizations of KPIs. Consequently, anomalous KPI data may be overlooked. As a result, the enterprise's operations may not run as efficiently as they could, and issues that may negatively impact the enterprise's operations may persist unrecognized. Accordingly, new techniques for detecting and communicating anomalies in the data of one or more KPIs for monitoring an enterprise's operations are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of this disclosure, a method may be practiced by first retrieving, via a call to an API endpoint, key performance indicator (KPI) data corresponding to a plurality of KPIs. Then, the method includes identifying a plurality of anomalies in the KPI data, wherein each anomaly of the plurality of anomalies corresponds to a respective KPI of the plurality of KPIs. The method includes generating a plurality of notifications based on the plurality of anomalies, wherein each of the plurality of notifications includes information about a respective anomaly of the plurality of anomalies. The method includes ranking plurality of notifications based on a ranking of the plurality of KPIs. Lastly, the method includes transmitting the plurality of notifications to a client device for display within a dashboard.

In an embodiment of this disclosure, the system may include processing circuitry and a non-transitory memory, accessible by the processing circuitry and storing instructions that, when executed by the processing circuitry, cause the processing circuitry to perform operations. The processing circuitry performs operations including retrieving, via a call to an API endpoint, key performance indicator (KPI) data corresponding to a plurality of KPIs, identifying a plurality of anomalies in the KPI data, wherein each anomaly of the plurality of anomalies corresponds to a respective KPI of the plurality of KPIs, and generating a plurality of notifications based on the plurality of anomalies, wherein each of the plurality of notifications includes information about a respective anomaly of the plurality of anomalies. Additionally, the processing circuitry performs operations including ranking the plurality of KPIs and then ranking the plurality notifications based on the ranking of the plurality of KPIs. Lastly, the processing circuitry performs operations including transmitting the plurality of notifications to a client device for display within a dashboard.

In an embodiment of this disclosure, a non-transitory, computer readable medium includes instructions that, when executed by processing circuitry, cause the processing circuitry to perform operations including retrieving, via a call to an API endpoint, key performance indicator (KPI) data corresponding to a plurality of KPIs; identifying a plurality of anomalies in the KPI data, wherein each anomaly of the plurality of anomalies corresponds to a respective KPI of the plurality of KPIs; generating a plurality of notifications based on the plurality of anomalies, wherein each of the plurality of notifications includes information about a respective anomaly of the plurality of anomalies; ranking the KPIs; ranking the plurality of notifications based on the ranking of the plurality of KPIs; generating a plurality of suggestions based on the plurality of anomalies, wherein each of the plurality of suggestions addresses a respective anomaly of the plurality of anomalies; transmitting the plurality of notifications and the plurality of suggestions to a client device for display within a dashboard; and implementing the plurality of suggestions.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server enables the client instance and also hosts data for key performance indicators (KPIs) and dashboards, in accordance with aspects of the present disclosure;

FIG. 5 is a schematic diagram of an embodiment of one of the dashboards displaying visualizations of KPIs, in accordance with aspects of the present disclosure;

FIG. 6 is schematic diagram of an embodiment of the dashboard displaying visualizations of KPIs and notifications regarding anomalies in the KPIs, in accordance with aspects of the present disclosure; and

FIG. 7 is a flowchart illustrating a method of displaying the notifications in order of priority, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Various embodiments disclosed herein are directed to a system for analyzing the data of one or more KPIs for anomalies. The system retrieves KPI data by making a call to an endpoint via an API at some defined interval (e.g., hourly, daily, weekly, monthly, quarterly, annually, etc.). The system analyzes the retrieved KPI data to identify anomalies within the KPI data. For example, anomalies may include an abnormal signal, a failure to reach a target, a trend pattern, and so forth. If the system detects an anomaly in the data of one or more KPIs, the system may further identify at least one contributing factor associated with the detected anomaly. In response to detecting multiple anomalies, the system may rank respective notifications resulting from the anomalies based on a ranking of the KPIs associated with the notifications. The system may then generate notifications for display on a dashboard that describes the respective anomalies and corresponding contributors. The system may be configured to identify a KPI associated with the notification. In some embodiments, the system may be configured to output suggestions to address anomalies based on an analysis of the at least one contributing factor.

Furthermore, the system may be configured to prioritize displaying the most relevant notifications within the dashboard. In this manner, the computing system may determine the priority order of the various KPIs based on various factors such as a role within the organization, the amount of interaction a KPI receives on the dashboard, and/or the number of times a KPI appears on the dashboard. The system may organize a display of notifications according to the priority order of the respective KPIs. The system may further organize the display of notifications on the dashboard such that notifications based on certain threshold values (i.e., notifications that satisfy a threshold are displayed first, and notifications that do not satisfy the threshold are not displayed or displayed last). In some implementations, the system organizes the display of notifications on the dashboard chronologically. The dashboard may also be configured to output a limited number of suggestions. For example, the dashboard may only output suggestions to address the anomaly in a KPI with a highest priority order. As such, the system reduces noise on the dashboard and increases the visibility of notifications and suggestions for high priority KPIs. Furthermore, the system results in a more efficient utilization of resources and computing power by reducing the amount of information the system must transmit.

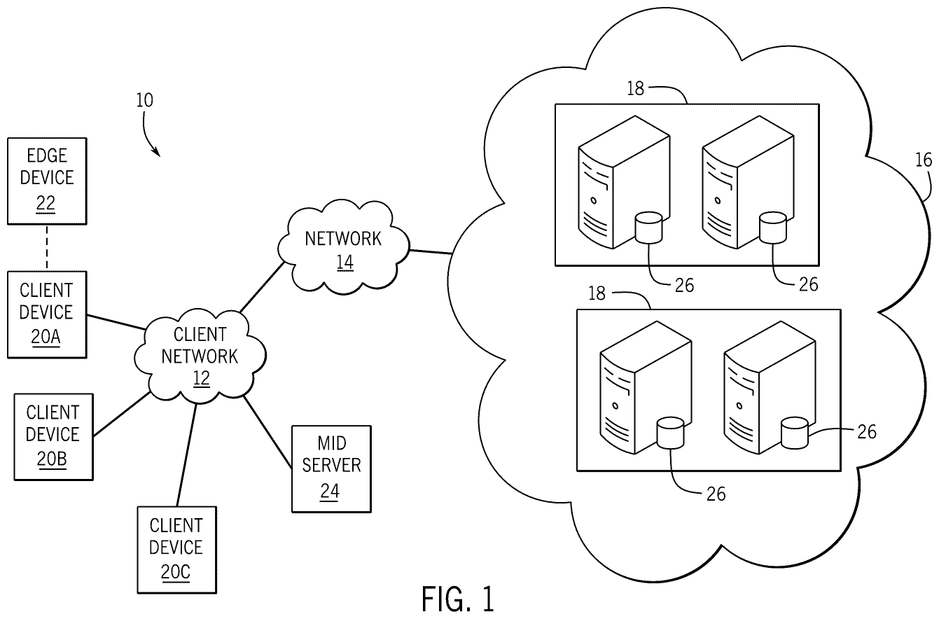

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

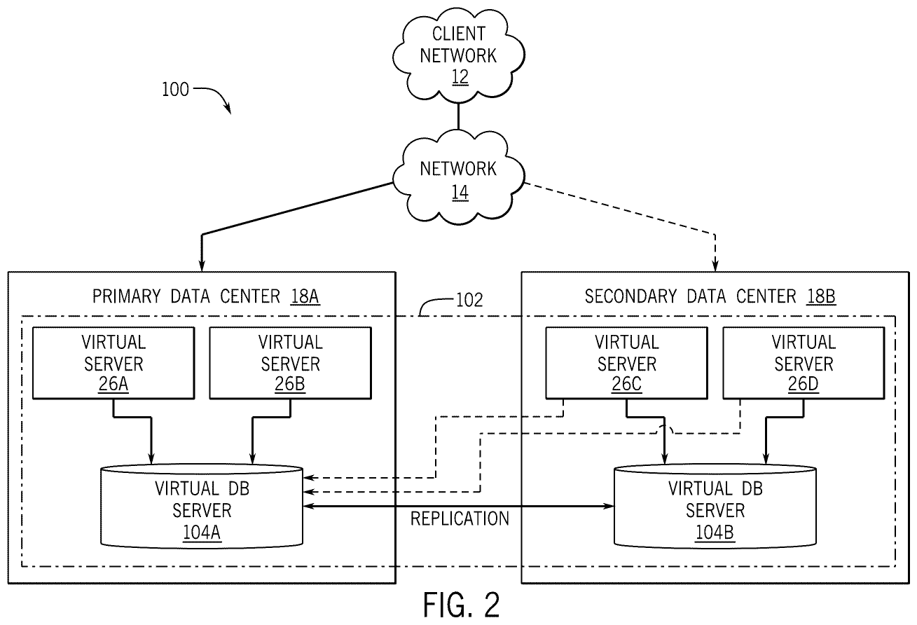

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

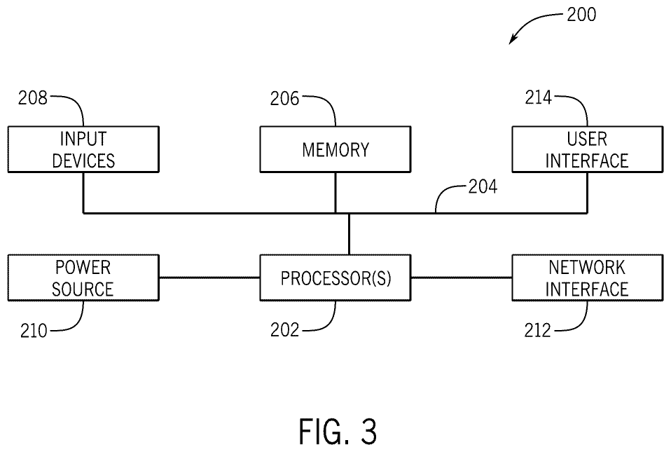

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

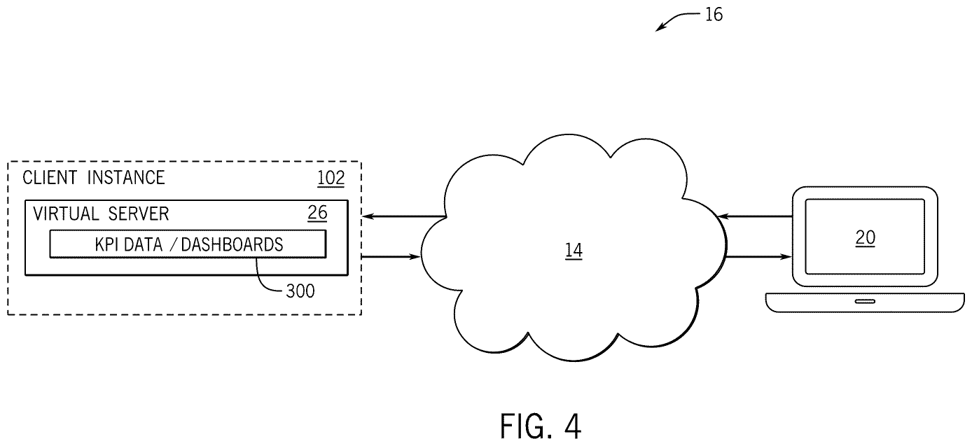

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser running on the client device 20). Client instance 102 is supported by virtual servers 26 similar to those explained with respect to FIG. 2, and is illustrated here to show support for the disclosed functionality described herein within the client instance 102. For example, in the illustrated embodiment, the virtual server 26 includes or has access to databases storing data for key performance indicators (KPIs) data and/or dashboards 300. Accordingly, the virtual server may be configured to use the data 300 and one or more algorithms to calculate one or more KPIs, analyze KPIs (e.g., identify trends, anomalies, etc.) and/or generate one or more dashboards and transmit the resulting KPIs and/or dashboards to the client device 20 for display. Alternatively, the virtual server 26 may be configured to transmit data 300 to the client device 20, which the client device uses to calculate KPIs and/or dashboards for display via the client device 20.

Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

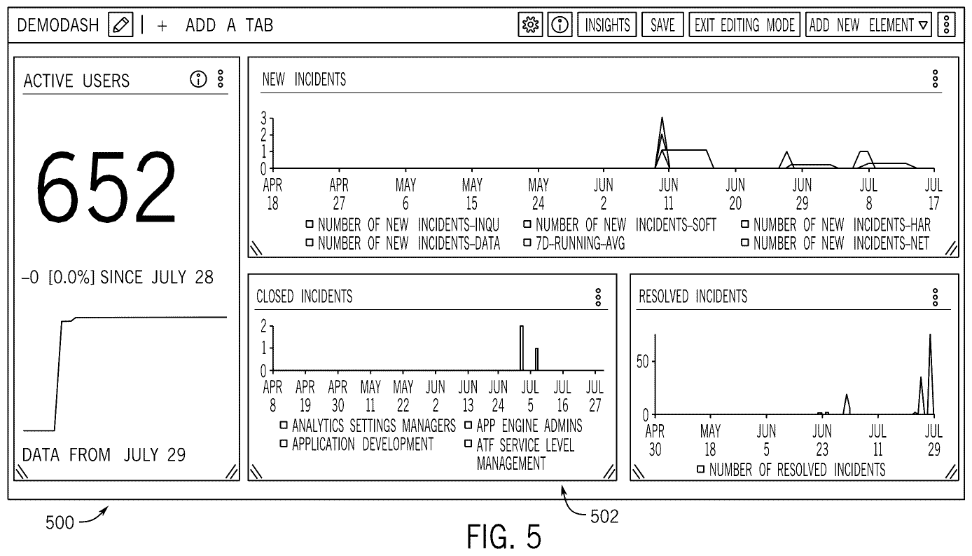

FIG. 5 is a schematic diagram of a dashboard 500 displaying visualizations 502 of KPIs, in accordance with aspects of the present disclosure. KPIs may include measurable values used to assess an enterprise's operations, and can be used to identify trends and make data-driven decisions. KPIs may include, for example, revenue metrics, churn rates, website traffic, and the like. KPIs may be aggregated and displayed as one or more data visualizations 502 on the dashboard 500. These visualizations 502 can include score displays, pie charts, bar charts, time series displays, line graphs, and so on.

The cloud-based platform 16 may generate the dashboard and output the dashboard 500 on the client device 20 for display as a user interface. The dashboard may include multiple visualizations 502 of KPIs (e.g., widgets). Each dashboard 500 may be customizable. For example, the dashboard 500 may be configured such that the user may look up additional KPIs and add the visualizations 502 of the additional KPIs to the dashboard 500. Additionally, the dashboard 500 may be set up according to a role within an organization. For example, the dashboard 500 corresponding to a profile of a user within an IT department may contain visualizations 502 of KPIs such as new cases, closed cases, and resolved cases. The dashboard 500 may also be configured such that the user can remove visualizations 502 of KPIs from the dashboard 500. Additionally and/or alternatively, the dashboard 500 may be configured to automatically remove visualizations 502 of KPIs with which the user has not interacted in a threshold time period.

In some embodiments, the layout of the dashboard 500 and the locations of the visualizations 502 of KPIs may be customizable. In other embodiments, the computing system may automatically arrange the location of the visualizations 502 of KPIs on the dashboard 500 based on various factors. These various factors may include, for example, a role within the organization, the amount of measured interaction with a KPI on the dashboard, and/or the number of times a KPI appears on the dashboard. It should be understood, however, that the dashboard shown in FIG. 5 is merely an example and that other embodiments are envisaged in which the dashboard 500 includes a different layout, different visualizations 502, different KPIs, and so forth.

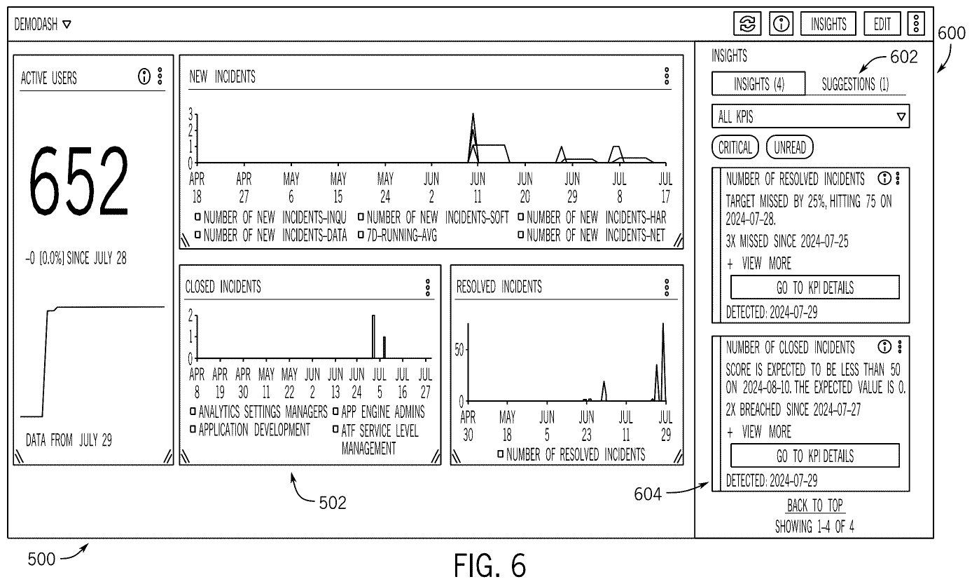

FIG. 6 is schematic diagram of the dashboard 500 displaying visualizations 502 of KPIs and notifications 604 regarding anomalies in the KPIs, in accordance with aspects of the present disclosure. The system may be configured to detect anomalies and their contributing factors (e.g., characteristics that may be causing or contributing to the anomaly). The system may then output a notification 604 describing a detected anomaly and its contributing factors. The notifications may be displayed in a side panel 600.

The system may detect anomalies during processing of the KPI data. An anomaly may include an undesirable trend in the KPI data, a KPI signal (i.e., a deviation from the expected range of data for a respective KPI), missing a target, exceeding a threshold, deviating from a target range or values, abnormally low or high values, or any other data pattern. The system may be configured to determine which data patterns constitute an anomaly. The system may use machine learning techniques to determine a normal distribution of data for a respective KPI. For example, a KPI regarding the number of closed cases of an IT team may have a relatively consistent annual distribution while a KPI regarding the income of a large retail store may have predictable peaks in the annual distribution coinciding with particularly busy shopping times (i.e., back-to-school shopping, holiday shopping, etc.). Thereafter, the system may be configured to determine that there is an anomaly if the KPI data is outside of the normal distribution of data of the respective KPI. The system may also use machine learning techniques to determine KPI data is anomalous based on the user interaction with the KPI. For example, the system may flag a certain data pattern as constituting the anomaly if there have been multiple interactions with the KPI when the KPI data included the certain data pattern. Additionally and/or alternatively, a user input may define the anomaly. For example, the input may set a particular value as the target and specify a time period in which to achieve the target. Consequently, the system may determine the KPI data is anomalous if the KPI data does not reach the target within the time period. As another example, the user input may set an upper threshold value and/or a lower threshold value. If the KPI data exceeds the upper threshold value or falls below the lower threshold value, the system may determine the KPI data is anomalous. The system may be configured to label the anomaly as critical (i.e., above a particular threshold) if the anomaly deviates greatly from the normal distribution of data of the respective KPI, the anomaly greatly exceeds or falls below the upper threshold value or the lower threshold value respectively, or the anomaly fails to reach the target. The system may store previously detected anomalies in the memory 206. The system may be configured to detect repeated anomalies. For example, the system may detect an anomaly in a respective KPI data and then check the memory 206 to determine if the previously detected anomalies in the respective KPI data are similar to currently detected anomaly.

Upon detecting the anomaly, the system may determine at least one contributing factor causing the anomaly. The system may use machine learning techniques to determine the contributing factor. For example, the system may detect that a change in a first KPI causes an anomaly in the data of a second KPI. The system may then determine the change in the first KPI was a contributing factor to the anomaly. Additionally and/or alternatively, the system may use the internet, user inputs, and past data to determine the contributing factor.

Once the anomaly is detected, the system may generate a notification 604. The notification 604 may identify the KPI and describe the anomaly associated with the respective KPI. The notification may include a summary of the anomaly, such as the type of anomaly, the data points constituting the anomaly, and/or the length of the time over which the anomaly has occurred. The notification 604 may also describe contributing factors associated with the anomaly. The notification 604 may include a timestamp of when the anomaly was detected. The system may be configured to detect whether a previously detected anomaly in the KPI data is similar to a new anomaly. If so, the notification 604 may include information regarding the previously detected anomaly, including any information contained on the notification 604 associated with the previously detected anomaly, when the previously detected anomaly was detected, and the contributing factors associated with the previously detected anomaly. If multiple previously detected anomalies are identified as similar to the new anomaly, the notification 604 associated with the new anomaly may bundle the previously detected anomalies. For example, if the system identifies three previously detected anomalies similar to the new anomaly, the notification 604 may include a statement such as “detected 3× since 2024 Jul. 25.” Furthermore, the notification 604 may include a toggle configured to display the respective notifications of each of the bundle of previously detected anomalies when selected.

A plurality of notifications 604 may be displayed on the dashboard 500. In the pictured embodiment, the notifications 604 are displayed in the side panel 600. However, the notifications 604 may be displayed in a notification window, a pop-up window, alongside the visualizations 502 of the KPIs, and/or in a separate tab from the visualizations 502 of the KPIs in the dashboard 500. The system may include a toggle in the notification 604 that, when selected, displays the underlying KPI data. The system may be configured to allow the user to sort the notifications 604. The user may sort the notifications 604 based on whether their critical label, their read status, their recency, and various other factors. Additionally, the system may automatically sort the notifications 604. The system may sort the notifications 604 based on their critical label, their read status, their recency, the type of anomaly described in the notification 604, the priority of the KPI identified in the notification 604, and various other factors. The system may also limit the number of notifications 604 displayed at a given time. For example, the system may be configured to display three or fewer notifications 604 in the side panel 600. The system may only display notifications 604 where the associated anomaly is labeled critical and/or notifications 604 that identify high priority KPIs.

The system may generate a suggestion 602 to address the anomaly and/or improve the KPI performance based on an analysis of the at least one contributor. The suggestion may include information identifying the KPI it is associated with and/or a timestamp. The suggestion 602 may be at least one step to be performed by the computing system. The system may generate a suggestion 602 upon detecting the anomaly. The system may also generate a suggestion 602 in response to detecting undesirable data patterns that do not constitute the anomaly. For example, the system may generate a suggestion 602 to increase prices if the system detects the KPI data denoting profits is trending down. As another example, the system may generate a suggestion 602 to set up a discussion between a first team and a second team if the system determines a number of cases involving the first team and the second team exceeds a threshold. Additionally, the system may generate a suggestion 602 to raise the target if the system determines the target has been met and is lower than an industry benchmark. In some embodiments, the suggestion 602 is only generated if the system displays the notification 604 associated with the anomaly. The system may use machine learning techniques, user input, or resources from the internet to analyze the contributing factors and generate the suggestion 602.

In the pictured embodiment, the suggestion 602 is displayed in the side panel 600. However, the suggestion 602 may be displayed in a pop-up window, adjacent to the visualizations 502 of the KPIs, and/or in a separate tab from the visualizations 502 of the KPIs in the dashboard 500. Additionally, the dashboard may be configured to display a plurality of suggestions. In such embodiments, the system may limit the number of suggestions 602 displayed at a given time. For example, the system may only display a threshold number of suggestions 602 associated with high priority KPIs.

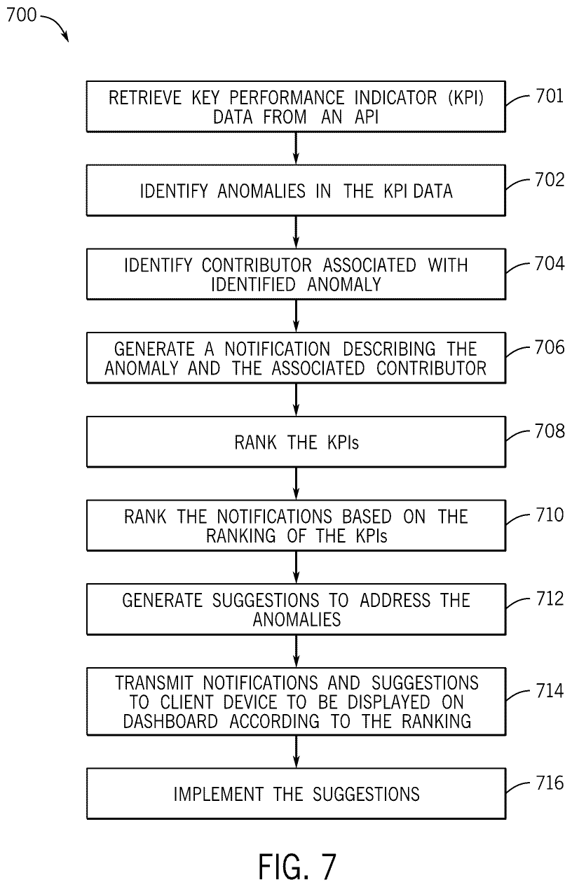

FIG. 7 is a flowchart illustrating a process 700 of displaying the notifications in order of priority, in accordance with aspects of the present disclosure.

In block 701, the system retrieves the KPI data by making a call to an endpoint via an API at a defined interval. The defined interval may be hourly, daily, weekly, monthly, annually, or any other time period in which the changes in the KPI data may be significant. In further embodiments, KPI data may be retrieved on demand or when certain conditions are met (e.g., upon startup, etc.). Additionally, the system may transmit the KPI data to be displayed as visualizations 502 of the KPIs on the dashboard 500.

Upon receiving the KPI data, the system may analyze the KPI data to identify anomalies in block 702. The anomalies may occur when the KPI data shows an undesirable trend, deviates from the expected range of data, fails to reach the target, and/or exceeds or falls below the upper threshold value or the lower threshold value, respectively. The system may use machine learning techniques to identify anomalies. The system may also rely on user inputs to define the anomalies.

Upon identifying the anomalies, the system may identify at least one contributing factor associated with each of the anomalies in block 704. The contributing factors may describe the underlying cause of each anomaly. For example, the contributing factor may include a time of year, a worker's strike, interest rates, and/or inflation. The system may use machine learning techniques and/or user inputs to determine the contributing factors.

In process block 706, the system may generate notifications 604 describing each anomaly and its associated contributing factor. The notifications 604 may identify the KPI with which each anomaly is associated. The notifications 604 may contain additional information. For example, the notifications may identify previously detected anomalies and their associated contributing factors similar to the currently detected anomaly. As another example, the notifications may identify the type of anomaly described and/or identify the particular data points that constitute the anomaly.

In block 708, the system may rank the KPIs. The KPIs may be ranked according to various factors. One of the various factors is the role within the organization. For example, if the user is in the sales department, the system may rank the KPI related to number of sales over the KPI related to numbers of cases IT has closed. Another of the various factors is the amount of interaction a KPI receives on the dashboard 500. Thus, the KPI that has the most measured interaction is ranked higher than the KPIs with less measured interaction. Lastly, one of the various factors is the number of times a KPI appears on different dashboards. Therefore, if a KPI appears on multiple dashboards across the organization, users of the platform, or other groups of dashboards 500, the KPI is ranked higher. Each ranking may be customized to each dashboard 500. The KPIs may be ranked according to one factor or any combination of factors. Once the KPIs are ranked, the system may determine a priority order of the KPIs. The priority order may be updated daily. The ranking as described allows the system to automatically determine the relative importance of each KPI as reflected in the priority order. By using the various factors in the ranking, the priority order is flexible and responsive to changing conditions affecting KPI data. Furthermore, the system can utilize the priority order to streamline the dashboard and increase efficiency such that the dashboard only displays the highest priority KPI or displays the highest priority KPIs near the top of the dashboard.

In block 710, the system may rank the notifications 604 based on the priority order of the KPIs with which each notification 604 is associated. Thus, a notification 604 associated with a highest priority order KPI may be first in the ranking of notifications 604, and so forth. Once the notifications 604 are ranked according the priority order of the KPIs, the system may further organize the rankings based on recency. As such, the system may be configured to remove notifications 604 from the rankings after a threshold number of hours or days. Alternatively, the system may be configured to alter the ranking so that notifications 604 are ranked lower as they get older. The system may also further organize the rankings based on whether the notification regards an anomaly that is labeled critical (i.e., a critical notification). In some embodiments, the system may be configured to rank any critical notifications 604 above other non-critical notifications 604. In such an embodiment, the system may be configured to organize the critical notifications 604 according to the priority order of the KPIs with which each critical notification 604 is associated. The ranking as described allows the system to automatically determine the relative importance of each notification 604 as reflected in the priority order of the KPIs. The system may then utilize the rankings to determine which of the notifications 604 are output on the dashboard such that only the most important notifications 604 are displayed. This increases the efficiency of the system as it decreases the noise on the dashboard, ensures visibility of the important notifications 604, and reduces computing power required to transmit the notifications 604.

In block 712, the system may generate a suggestion 602 to address the anomaly identified in block 702. The suggestion 602 may be at least one step to be performed by the computing system, wherein the suggestion 602 is configured to change the KPI data in a manner to eliminate the anomaly. For example, the suggestion 602 may be configured to increase the values of the KPI data if the anomaly constitutes a downward data trend. The system may use machine learning techniques, user input, or resources from the internet to generate the suggestion 602. The system may generate a suggestion 602 for each notification 604 generated.

In process block 714, the system may transmit the notification 604 and the suggestion 602 to the client device to be displayed on the dashboard 500 according to the ranking of the notifications 604. The system may display the notifications 604 in the order of their rankings. The system may also display the suggestions 602 in the order of the rankings of the notifications 604 each suggestion 602 is associated with. In some embodiments, the system may only transmit a select number of notifications 604 and suggestions 602. In such embodiments, the system may only transmit the highest ranked notifications 604 and their associated suggestions 602. Thus, the dashboard 500 only displays the most relevant notifications 604 and suggestions 602.

In process block 716, the system may implement the suggestion 602. As discussed herein, the suggestion 602 may be at least one step to be performed by the computing system. Thus, the system may be configured to automatically perform the steps constituting the suggestion 602 upon generating the suggestion 602 or transmitting the suggestion 602 to the dashboard. The system may access the network to perform the steps. For example, if the suggestion 602 recommends a price increase to increase profits, the system may automatically access the network 14 and increase the prices on the organization's website. As another example, if the suggestion 602 recommends setting up the discussion between the first team and the second team as disclosed herein, the system may automatically create a communication thread between members of the first team and members of the second team. Lastly, if the suggestion 602 recommends raising the target because the target has been met and is lower than an industry standard, the system may raise the target by a pre-defined value and may either automatically implement the raised target or request approval to implement the raised target. In some embodiments, the suggestion 602 may be implemented upon receiving a user input authorizing the steps to be performed.

Thus, the system is directed to analyzing the data of one or more KPIs for anomalies and contributing factors. The system may then generate notifications 604 for display on a dashboard 500 that describes the respective anomalies and corresponding contributing factors. In some embodiments, the system may be configured to output suggestions 602 to address anomalies based on an analysis of the at least one contributing factor. Furthermore, the system may be configured to prioritize displaying the most relevant notifications 604 within the dashboard 500 based on the priority order of the various KPIs each notification 604 is associated with. The dashboard 500 may also be configured to output a limited number of notifications 604 and suggestions 602.

Various embodiments disclosed herein are directed to a system for analyzing the data of one or more KPIs for anomalies. The system retrieves KPI data by making a call to an endpoint via an API at some defined interval (e.g., hourly, daily, weekly, monthly, quarterly, annually, etc.). The system analyzes the retrieved KPI data to identify anomalies within the KPI data. For example, anomalies may include an abnormal signal, a failure to reach a target, a trend pattern, and so forth. If the system detects an anomaly in the data of one or more KPIs, the system may further identify at least one contributing factor associated with the detected anomaly. In response to detecting multiple anomalies, the system may rank respective notifications resulting from the anomalies based on a ranking of the KPIs associated with the notifications. The system may then generate notifications for display on a dashboard that describes the respective anomalies and corresponding contributors. The system may be configured to identify a KPI associated with the notification. In some embodiments, the system may be configured to output suggestions to address anomalies based on an analysis of the at least one contributing factor.

Furthermore, the system may be configured to prioritize displaying the most relevant notifications within the dashboard. In this manner, the computing system may determine the priority order of the various KPIs based on various factors such as a role within the organization, the amount of interaction a KPI receives on the dashboard, and/or the number of times a KPI appears on the dashboard. The system may organize a display of notifications according to the priority order of the respective KPIs. The system may further organize the display of notifications on the dashboard such that notifications based on certain threshold values (i.e., notifications that satisfy a threshold are displayed first, and notifications that do not satisfy the threshold are not displayed or displayed last). In some implementations, the system organizes the display of notifications on the dashboard chronologically. The dashboard may also be configured to output a limited number of suggestions. For example, the dashboard may only output suggestions to address the anomaly in a KPI with a highest priority order. As such, the system reduces noise on the dashboard and increases the visibility of notifications and suggestions for high priority KPIs. Furthermore, the system results in a more efficient utilization of resources and computing power by reducing the amount of information the system must transmit.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method comprising:
retrieving, via a call to an API endpoint, key performance indicator (KPI) data corresponding to a plurality of KPIs;
identifying a plurality of anomalies in the KPI data, wherein each anomaly of the plurality of anomalies corresponds to a respective KPI of the plurality of KPIs;
generating a plurality of notifications based on the plurality of anomalies, wherein each of the plurality of notifications includes information about a respective anomaly of the plurality of anomalies;
ranking the plurality of notifications based on a ranking of the plurality of KPIs; and
transmitting the plurality of notifications to a client device for display within a dashboard.

2. The method of claim 1, further comprising identifying a contributing factor associated with a particular anomaly of the plurality of anomalies corresponding to a particular notification of the plurality of notifications, wherein the notification identifies the contributing factor.

3. The method of claim 1, further comprising:
generating at least one suggestion for improving at least one of the plurality of KPIs; and
transmitting the at least one suggestion to the client device for display within the dashboard.

4. The method of claim 1, wherein the plurality of notifications is displayed within a notification window of the dashboard according to the ranking of the respective notifications.

5. The method of claim 4 further comprising:
determining whether each of the plurality of anomalies falls below a particular threshold; and
adjusting the ranking of the plurality of notifications based on the determination that the respective anomaly of each of the plurality of notifications falls below the particular threshold.

6. The method of claim 4, wherein the ranking of the plurality of KPIs is determined based on how often each of the plurality of KPIs appears on the dashboard.

7. The method of claim 4, wherein the ranking of the plurality of KPIs is determined based on a role within an organization.

8. The method of claim 4, wherein the ranking of the plurality of KPIs is determined based on respective amounts of measured interaction with each of the plurality of KPIs on the dashboard.

9. The method of claim 1, wherein the plurality of anomalies comprises KPI data failing to reach a specified target within a particular period of time.

10. The method of claim 1, wherein at least one anomaly of the plurality of anomalies comprises a KPI signal being outside of an expected range of values.

11. A system comprising:
processing circuitry; and
a non-transitory memory, accessible by the processing circuitry and storing instructions that, when executed by the processing circuitry, cause the processing circuitry to perform operations comprising:
retrieving, via a call to an API endpoint, key performance indicator (KPI) data corresponding to a plurality of KPIs;
identifying a plurality of anomalies in the KPI data, wherein each anomaly of the plurality of anomalies corresponds to a respective KPI of the plurality of KPIs;
generating a plurality of notifications based on the plurality of anomalies, wherein each of the plurality of notifications includes information about a respective anomaly of the plurality of anomalies;
ranking the plurality of KPIs;
ranking the plurality of notifications based on the ranking of the plurality of KPIs; and
transmitting the plurality of notifications to a client device for display within a dashboard.

12. The system of claim 11, wherein the plurality of notifications is displayed within the dashboard according to the ranking of the respective notifications.

13. The system of claim 12, wherein the dashboard is configured to display a threshold number of the plurality of notifications comprising a top threshold number of ranked notifications of the plurality of notifications.

14. The system of claim 11, wherein the operations further comprise:
storing the plurality of anomalies in the non-transitory memory;
detecting a new anomaly for a respective KPI of the plurality of KPIs;
retrieving a set of anomalies of the plurality of anomalies for the respective KPI from the non-transitory memory;
determining if each of the set of anomalies for the respective KPI is related to the new anomaly; and
generating a notification based on the new anomaly, wherein the notification includes information regarding each of the set of anomalies for the respective KPI related to the new anomaly.

15. The system of claim 11, wherein identifying the plurality of anomalies in the KPI data is based a machine learning algorithm.

16. The system of claim 11, wherein the operations further comprise identifying a contributing factor associated with a particular anomaly of the plurality of anomalies corresponding to a particular notification of the plurality of notifications, wherein the notification identifies the contributing factor.

17. The system of claim 11, wherein the operations further comprise:
generating a suggestion for improving a particular KPI of the plurality of KPIs, wherein the suggestion comprises a step performed by the processing circuitry;
transmitting the suggestion to the client device for display within the dashboard; and
implementing the suggestion via the processing circuitry.

18. A non-transitory, computer readable medium comprising instructions that, when executed by processing circuitry, cause the processing circuitry to perform operations comprising:
retrieving, via a call to an API endpoint, key performance indicator (KPI) data corresponding to a plurality of KPIs;
identifying a plurality of anomalies in the KPI data, wherein each anomaly of the plurality of anomalies corresponds to a respective KPI of the plurality of KPIs;
generating a plurality of notifications based on the plurality of anomalies, wherein each of the plurality of notifications includes information about a respective anomaly of the plurality of anomalies;
ranking the plurality of KPIs;
ranking the plurality of notifications based on the ranking of the plurality of KPIs;
generating a plurality of suggestions based on the plurality of anomalies, wherein each of the plurality of suggestions addresses a respective anomaly of the plurality of anomalies;
transmitting the plurality of notifications and the plurality of suggestion to a client device for display within a dashboard;
displaying the plurality of notifications within the dashboard according to the ranking of the respective notifications; and
implementing the plurality of suggestion.

19. The non-transitory, computer readable medium of claim 18, further comprising instructions that cause the processing circuitry to perform operations comprising identifying a contributing factor associated with a particular anomaly of the plurality of anomalies corresponding to a particular notification of the plurality of notifications, wherein the notification identifies the contributing factor.

20. The non-transitory, computer readable medium of claim 18, further comprising instructions that cause the processing circuitry to perform operations comprising:
ranking the plurality of suggestions based on the ranking of the plurality of KPIs; and
displaying the plurality of suggestions within the dashboard according to the ranking of the respective suggestions.
